(19) United States
(12) Patent Application Publication
(10) Pub. No.: US 2010/0134433 A1
(43) Pub. Date: Jun. 3, 2010

(54) Information-processing apparatus and imaging apparatus

(75) Inventor: Mikio Miyanishi, Osaka (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/592,054

(22) Filed: Nov. 18, 2009

(30) Foreign Application Priority Data
Dec. 3, 2008 (JP) P2008-308371

(51) Int. Cl. G06F 3/041

(52) U.S. Cl. 345/173

(57) ABSTRACT

An information-processing apparatus includes a display unit having a display screen, and processing means for detecting a touched position on the display screen and performing a processing operation corresponding to the touched position. The display screen has two or more regions arranged in a predetermined direction and being corresponding to respective different processing operations. The processing means includes limited-operation-processing means for limitedly performing, when a plurality of regions among the two or more regions are simultaneously touched with a first digit reached out in the predetermined direction, a processing operation corresponding to a first region nearest to the tip of the first digit.

### CROSS-REFERENCE TO RELATED APPLICATION

The present application claims priority from Japanese Patent Application No. JP 2008-308371 filed in the Japanese Patent Office on Dec. 3, 2008, the entire content of which is incorporated herein by reference.

### BACKGROUND OF THE INVENTION

1. Field of the Invention

The present invention relates to a technique of an information-processing apparatus that detects a touched position on a display screen and performs a processing operation corresponding to the touched position.

2. Description of the Related Art

Some imaging apparatuses (information-processing apparatuses) such as a digital camera include monitors equipped with touch panels (touched-position detectors) functioning as input means through which users make inputs. With such a touch panel, operation buttons and the like can be displayed in relatively large sizes on a monitor, and an input can be made only by lightly touching with the tip of a digit. This provides good operability.

In an exemplary imaging apparatus disclosed in Japanese Unexamined Patent Application Publication No. 2001-59984, twelve buttons (rectangular regions) initiating different processing operations when touched are arranged on a touch panel in a three-by-four matrix.

### SUMMARY OF THE INVENTION

The imaging apparatus disclosed in Japanese Unexamined Patent Application Publication No. 2001-59984, however, has the following problem. An exemplary case will be considered where touch-operating any of the buttons is attempted with the tip of the thumb of the right hand with which the imaging apparatus is held. To touch-operate a button positioned farther from the right hand, the thumb reached out toward the left covers a plurality of buttons. Therefore, not only the tip of the thumb but also the other portion of the thumb may touch the plurality of buttons. Consequently, the touch panel may simultaneously detects a plurality of touches on the plurality of buttons with a single digit, resulting in failure in properly performing a processing operation intended by the user.

In light of the above, it is desirable that the present invention provide a technique of an information-processing apparatus capable of performing an intended processing operation even if a plurality of touches with a single digit are simultaneously detected by a touched-position detector.

According to a first embodiment of the present invention, an information-processing apparatus includes a display unit having a display screen, and processing means for detecting a touched position on the display screen and performing a processing operation corresponding to the touched position. The display screen has two or more regions arranged in a predetermined direction and being corresponding to respective different processing operations. The processing means includes limited-operation-processing means for limitedly performing, when a plurality of regions among the two or more regions are simultaneously touched with a first digit reached out in the predetermined direction, a processing operation corresponding to a first region nearest to the tip of the first digit.

According to a second embodiment of the present invention, an imaging apparatus includes a display unit having a display screen, and processing means for detecting a touched position on the display screen and performing a processing operation corresponding to the touched position. The display screen has two or more regions arranged in a predetermined direction and being corresponding to respective different processing operations. The processing means includes limited-operation-processing means for limitedly performing, when a plurality of regions among the two or more regions are simultaneously touched with a first digit reached out in the predetermined direction, a processing operation corresponding to a first region nearest to the tip of the first digit.

The apparatus according to each of the embodiments of the present invention includes the processing means for detecting a touched position on the display screen of the display unit and performing a processing operation corresponding to the touched position. In the apparatus, when a plurality of regions among the two or more regions, which are arranged in the predetermined direction on the display screen and being corresponding to respective different processing operations, are simultaneously touched with the first digit reached out in the predetermined direction, a processing operation corresponding to the first region nearest to the tip of the first digit is limitedly performed. Consequently, even if a plurality of touches with the first digit are simultaneously detected by a touched-position detector, an intended processing operation can be performed.

### BRIEF DESCRIPTION OF THE DRAWINGS

FIG. 1 is an external view of an imaging apparatus according to an embodiment of the present invention;

FIG. 2 is another external view of the imaging apparatus;

FIG. 3 is another external view of the imaging apparatus;

FIG. 4 illustrates an information display area of an optical finder;

FIG. 5 is a block diagram showing the electrical configuration of the imaging apparatus;

FIGS. 6A and 6B illustrate the operation of a touch panel of the imaging apparatus;

FIG. 7 illustrates reasons for arranging icons in an L-shaped region of the touch panel;

FIG. 8 illustrates the reasons for arranging the icons in the L-shaped region of the touch panel;

FIGS. 9A to 9F illustrate exemplary profiles of guides;

FIG. 10 illustrates how one of the icons is operated when the imaging apparatus is in a horizontal orientation;

FIG. 11 illustrates how one of the icons is operated when the imaging apparatus is in the horizontal orientation;

FIG. 12 illustrates how one of the icons is operated when the imaging apparatus is in the horizontal orientation;

FIG. 13 illustrates how one of the icons is operated when the imaging apparatus is in a vertical orientation;

FIG. 14 illustrates how one of the icons is operated when the imaging apparatus is in the vertical orientation;

FIG. 15 illustrates the display operation of the optical finder performed when any of the icons is touch-operated;

FIG. 16 illustrates how one of the icons is operated with the thumb of the right hand when the imaging apparatus is in the vertical orientation;

FIG. 17 illustrates how one of the icons is operated with the thumb of the right hand when the imaging apparatus is in the vertical orientation;

FIG. 18 illustrates how one of the icons is operated with the thumb of the left hand when the imaging apparatus is in the vertical orientation;

FIG. 19 illustrates how one of the icons is operated with the thumb of the left hand when the imaging apparatus is in the vertical orientation;

FIGS. 20A and 20B illustrate the display operation of another optical finder having a liquid crystal panel performed when any of the icons is touch-operated;

FIGS. 21A and 21B illustrate the display operation of an electronic view finder performed when any of the icons is touch-operated; and

FIG. 22 illustrate the display operation of an external monitor performed when any of the icons of the imaging apparatus is touch-operated.

### DESCRIPTION OF THE PREFERRED EMBODIMENTS BASIC CONFIGURATION OF IMAGING APPARATUS

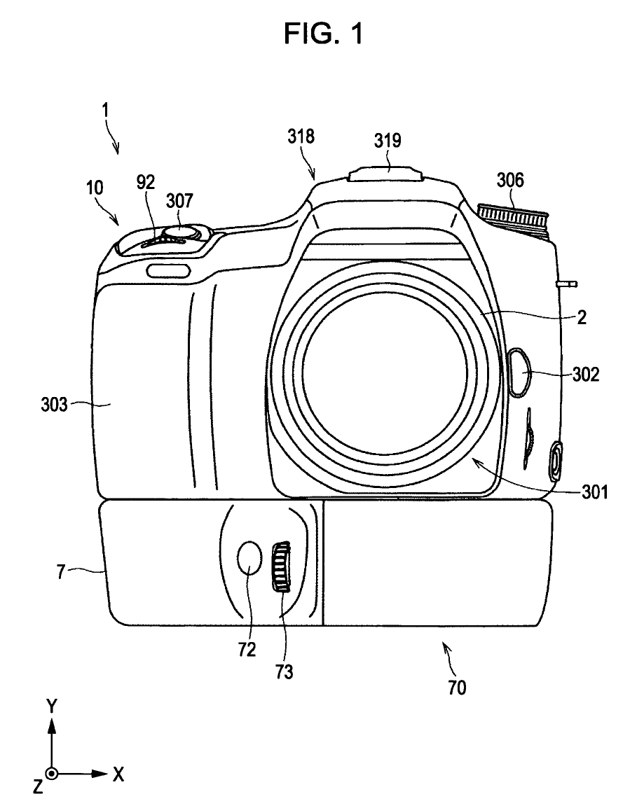

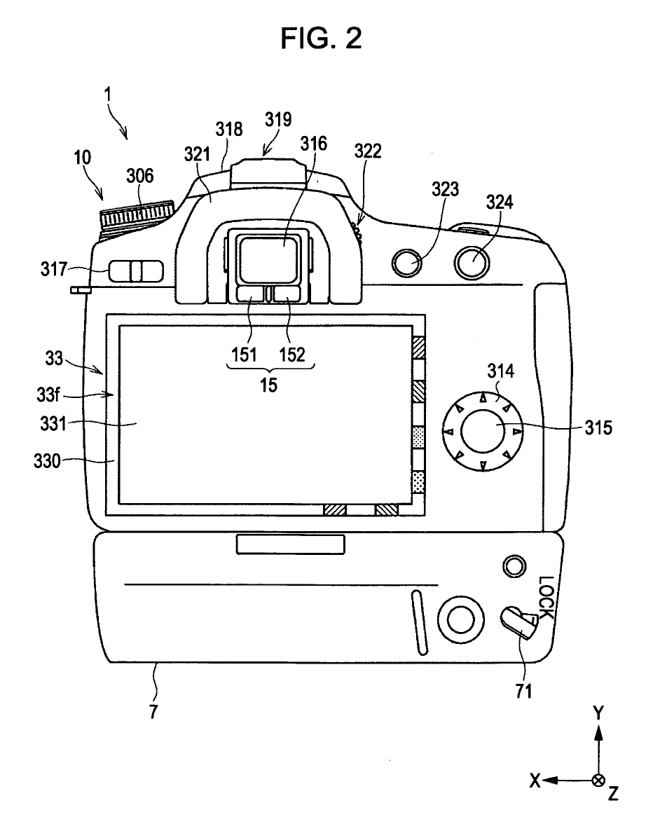

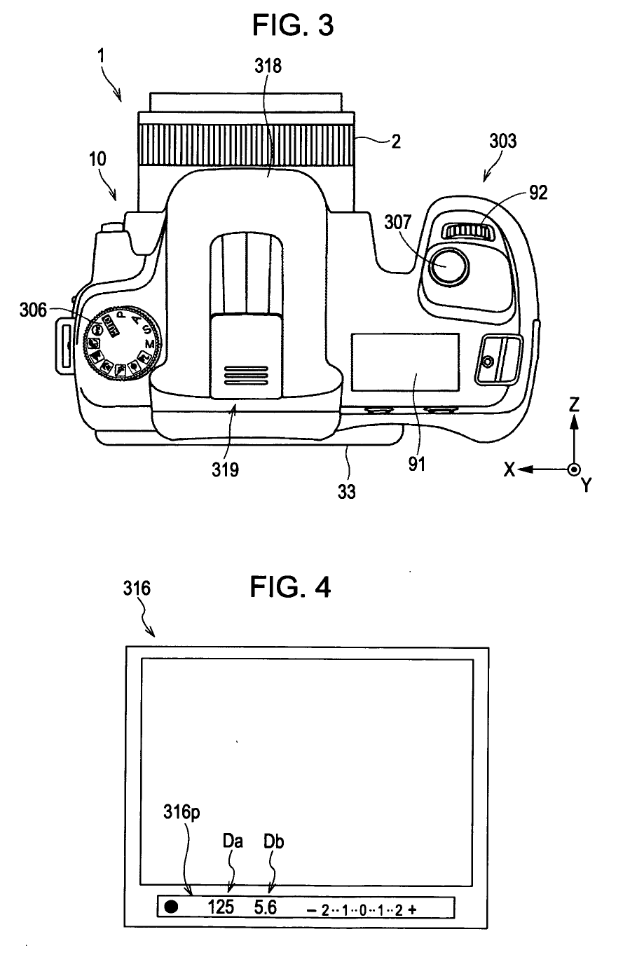

FIGS. 1 to 3 are external views of an imaging apparatus 1 according to an embodiment of the present invention. FIGS. 1 and 2 are a front view and a rear view, respectively, of the imaging apparatus 1 with a vertical-orientation control grip 7 attached thereto. FIG. 3 is a top view of the imaging apparatus 1. The imaging apparatus 1 functions as an information-processing apparatus configured as, for example, a single-lens-reflex digital still camera, and includes a camera body 10 and an interchangeable lens 2 functioning as an image-taking lens removable from the camera body 10.

Referring to FIG. 1, the camera body 10 has the following elements on the front side thereof: a mount 301 provided substantially in the center and on which the interchangeable lens 2 is mounted, a lens change button 302 provided on the right side of the mount 301, a grip 303 to be gripped by a user, a mode-setting dial 306 provided at the top right, and a shutter button 307 and an operation dial 92 provided at the top of the grip 303.

Referring to FIG. 2, the camera body 10 has the following elements on the rear side thereof: a rear monitor unit 33, a directional keypad 314 provided on the right side of the rear monitor unit 33, a push button 315 provided in the center of the directional keypad 314, an optical finder 316 provided on the upper side of the rear monitor unit 33, an eyecup 321 surrounding the optical finder 316, a main switch 317 provided on the left side of the optical finder 316, an exposure correction button 323 and a monitor-operating button 324 provided on the right side of the optical finder 316, and a flash 318 and a connection terminal 319 provided on the upper side of the optical finder 316.

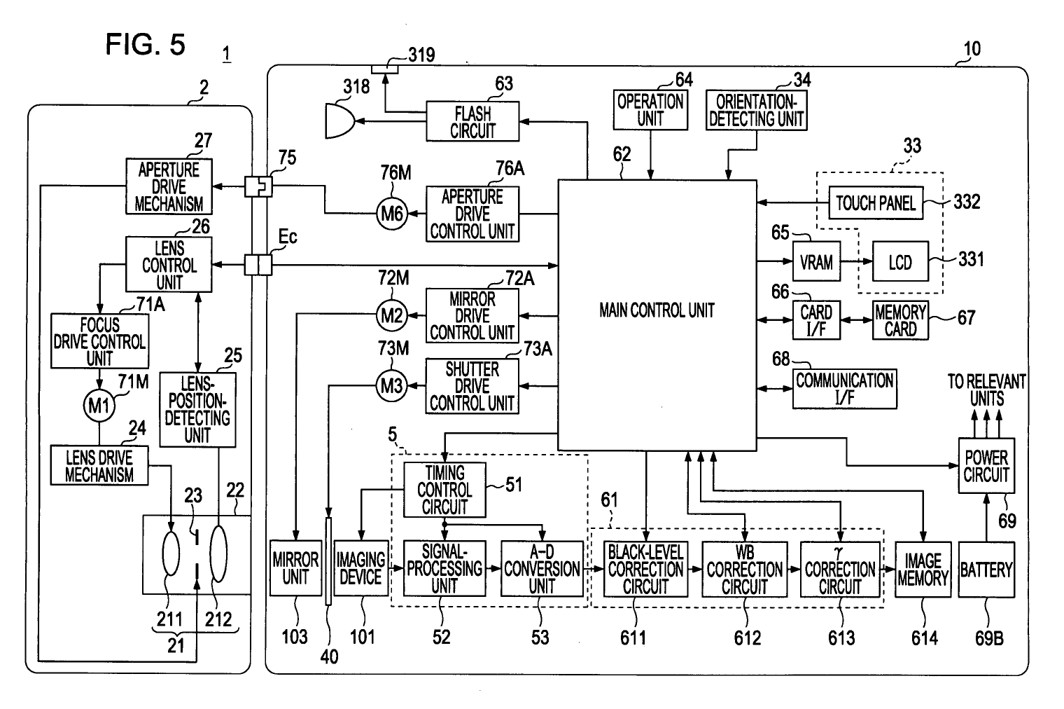

The mount 301 includes a connector Ec and a coupler (see FIG. 5) that establish electrical and mechanical connections, respectively, to the interchangeable lens 2 mounted thereon.

The lens change button 302 can be pressed down, whereby the interchangeable lens 2 mounted on the mount 301 can be removed.

The imaging apparatus 1 is gripped at the grip 303 by a user when the user performs shooting. The grip 303, provided on the right side of the rear monitor unit 33, has a curved surface so that the user's fingers can be fitted thereonto well. A battery housing and a card housing (both not shown) are provided inside the grip 303. The battery housing houses a battery 69B (see FIG. 5) as a power supply of the imaging apparatus 1. A memory card 67 (see FIG. 5) in which data of a shot image is recorded can be put into and removed from the card housing. The grip 303 may also be provided with a grip sensor that detects whether or not the grip 303 is gripped by a user.

The mode-setting dial 306 is used for selecting a mode from among various modes such as an autoexposure (AE) control mode, a manual-exposure (M) control mode, and shooting modes suitable for various shooting scenes.

The shutter button 307 is a press switch that can be pressed down halfway and all the way. When the shutter button 307 is pressed down halfway, a preparatory operation for shooting an object (preparations including exposure-parameter setting and focus adjustment) is performed. When the shutter button 307 is pressed down all the way, a shooting operation (a series of operations including exposure of an imaging device 101 (see FIG. 5), a specific image-processing operation of an image signal obtained by the exposure, and recording of data resulting from the processing operation into a memory card or the like) is performed.

The operation dial 92 is a rotatable operation member. By rotating the operation dial 92, various settings can be changed. That is, parameters of various shooting modes can be set by operating the operation dial 92.

The rear monitor unit 33, provided on the lower side of the optical finder 316, includes a liquid crystal display (LCD) 331 functioning as a display screen 33f capable of displaying a color image. The rear monitor unit 33 displays an image generated by the imaging device 101 (see FIG. 5) in the real shooting and reproduces a recorded image, for example. The rear monitor unit 33 also displays a setting screen in which the functions and modes of the imaging apparatus 1 are set. The rear monitor unit 33 can display a live-view image (a preview image) in which object images sequentially generated by the imaging device 101 (see FIG. 5) are displayed before the real shooting by orienting a mirror unit 103 (see FIG. 5) so as to be in a mirror-up position. The rear monitor unit 33 includes on the outer periphery thereof a frame 330 having an open rectangular shape.

The directional keypad 314 includes an annular member having a plurality of press points (represented by triangular marks in FIG. 2) radially defined at regular intervals, and a plurality of contact points (switches, not shown) provided in correspondence with the press points. The contact points detect whether or not the respective press points are pressed. The push button 315 is provided in the center of the directional keypad 314. The directional keypad 314 and the push button 315 are used in issuing instructions to perform, for example, autofocus drive, change of the focus-detecting position in the vertical, horizontal, and oblique directions, frame advancement of recorded images reproduced on the rear monitor unit 33 or the like, and setting of shooting conditions such as the International-Organization-for-Standardization (ISO) speed, white balance (WB), and use or nonuse of the flash.

The optical finder 316 is an ocular finder provided on the rear side of the camera body 10, and optically displays the range in which an object is to be shot. Specifically, an image of an object introduced through the interchangeable lens 2 is displayed on the optical finder 316, through which a user can view and recognize the actual image of the object taken by the imaging device 101. The optical finder 316 has an in-finder information display area (hereinafter referred to as “information display area”) 316p in a lower portion thereof. For example, when the shutter button 307 is pressed down halfway, the information display area 316p displays shooting information such as a shutter-speed indication Da and an f-number indication Db, as shown in FIG. 4, through a liquid crystal display panel (not shown) provided inside the imaging apparatus 1.

An eye-approach-detecting unit 15 is provided on the lower side of and adjoining the optical finder 316. The eye-approach-detecting unit 15 includes a light emitter 151 that emits infrared light and a light receiver 152. The eye-approach-detecting unit 15 detects the approach of an eye of a user to the optical finder 316 by causing the infrared light emitted from the light emitter 151, including a light-emitting diode (LED), to be reflected by the eye of the user and detecting the reflected light with the light receiver 152.

Referring to FIG. 2, the main switch 317 is a sliding switch that slides laterally between two contact points. The power of the imaging apparatus 1 is turned on when the main switch 317 is slid to the right, and is turned off when the main switch 317 is slid to the left.

The flash 318 is a built-in pop-up flash. An external flash or the like can be connected to the camera body 10 via the connection terminal 319.

The eyecup 321, having a U shape, has a light-shielding characteristic and functions as a light-shielding member that suppresses the entrance of external light into the optical finder 316.

The exposure correction button 323 is used for manually adjusting the exposure value (including the f-number and the shutter speed). The monitor-operating button 324 is used for manually switching the display format (between a detailed format, an enlarged format, and the like) of the rear monitor unit 33 and for turning on and off the light of the rear monitor unit 33. That is, the monitor-operating button 324 enables switching of the display screen 33f of the rear monitor unit 33 between a light-on state (a displaying state) and a light-off state (a non-displaying state).

Referring to FIG. 3, a top display panel 91 is provided at the top of the camera body 10. The top display panel 91 functions as another display unit different from the rear monitor unit 33 and displays the current settings.

The interchangeable lens 2 functions as a lens window through which light (an optical image) from an object is taken in, and also functions as an image-taking optical system through which the light from the object is guided to the imaging device 101 provided inside the camera body 10. The interchangeable lens 2 can be removed from the camera body 10 by pressing down the lens change button 302.

The interchangeable lens 2 includes a lens unit 21 (see FIG. 5) constituted by a plurality of lenses that are arranged in series along the optical axis of the interchangeable lens 2. The lens unit 21 includes a focus lens 211 (see FIG. 5) with which the focus is adjusted and a zoom lens 212 (see FIG. 5) with which the magnification is changed. Focus adjustment and magnification change are performed by moving the focus lens 211 and the zoom lens 212, respectively, along the optical axis of the interchangeable lens 2. The interchangeable lens 2 also includes at an appropriate position on the outer periphery of a lens barrel thereof an operation ring rotatable along the outer periphery of the lens barrel. The zoom lens 212 is manually or automatically moved along the optical axis in accordance with the rotating direction and the amount of rotation of the operation ring, whereby a zoom ratio (a shooting magnification) can be set in accordance with the resulting position of the zoom lens.

The vertical-orientation control grip 7 includes a gripped portion 70 and a locking switch 71. The gripped portion 70 is to be gripped by a user when the imaging apparatus 1 is used in a vertical orientation. In a state where the vertical-orientation control grip 7 is attached at the bottom of the imaging apparatus 1, the gripped portion 70 is positioned on the lower side of the rear monitor unit 33.

A shutter button 72 and an operation dial 73 are provided near the gripped portion 70. The shutter button 72 and the operation dial 73 are configured as are the shutter button 307 and the operation dial 92, respectively. When the imaging apparatus 1 is in the vertical orientation, the shutter button 72 enables the input of a shooting start instruction or the like with a feeling similar to that when operating the shutter button 307.

The locking switch 71 is a switch having a lever. The lever of the locking switch 71 can be turned to the left and the right, whereby the operation of the vertical-orientation control grip 7 is enabled and disabled.

### Electrical Configuration of Imaging Apparatus 1

FIG. 5 is a block diagram showing the electrical configuration of the imaging apparatus 1. In FIG. 5, elements shown in FIGS. 1 to 3 are denoted by the same reference numerals. The interchangeable lens 2 may be either of the following: a lens including thereinside a drive unit for autofocus, and a lens driven by the camera body when autofocus is performed. Herein, for convenience of description, the electrical configuration of the interchangeable lens 2 of the former one will be described.

The interchangeable lens 2 includes, in addition to the lens unit 21 functioning as an image-taking optical system as described above, a lens drive mechanism 24, a lens-position-detecting unit 25, a lens control unit 26, and an aperture drive mechanism 27.

The focus lens 211 and the zoom lens 212 of the lens unit 21 and an aperture 23, which adjusts the amount of light to be incident on the imaging device 101 provided in the camera body 10, are held in the lens barrel and along the optical axis of the interchangeable lens 2, whereby light from an object is taken in and is formed as an image on the imaging device 101. In autofocus (AF) control, an AF actuator 71M provided in the interchangeable lens 2 moves the focus lens 211 along the optical axis, whereby the focus is adjusted.

A focus drive control unit 71A generates a drive control signal in accordance with an AF control signal supplied from a main control unit 62 via the lens control unit 26. The drive control signal is used for moving the focus lens 211 to an in-focus position and is supplied to the AF actuator 71M. The AF actuator 71M, which is a stepping motor or the like, provides a lens-driving force to the lens drive mechanism 24.

The lens drive mechanism 24 includes, for example, a helicoid and a gear (not shown) that rotates the helicoid. The lens drive mechanism 24 receives the driving force from the AF actuator 71M and thus moves the focus lens 211 and other lenses in a direction parallel to the optical axis. The direction and amount of the movement of the focus lens 211 depend on the direction of revolution and the number of revolutions, respectively, of the AF actuator 71M.

The lens-position-detecting unit 25 includes an encoder plate and an encoder brush. The encoder plate has a plurality of code patterns arranged in the optical-axis direction at specific pitches within the range in which the lenses of the lens unit 21 move. The encoder brush moves together with the lenses while being slidably in contact with the encoder plate. Thus, the amounts of movements of the lenses of the lens unit 21 during focus adjustment are detected. The positions of the lenses detected by the lens-position-detecting unit 25 are output as, for example, the numbers of pulses.

The lens control unit 26 is a microcomputer including memories such as a read-only memory (ROM) that stores control programs and the like, and a flash memory that stores state information data.

The lens control unit 26 has a communication function enabling communication with the main control unit 62 of the camera body 10 via the connector Ec. Thus, the lens control unit 26 can send to the main control unit 62 state information data on the lens unit 21 including the focal length; the exit-pupil position; the f-number; the in-focus distance; and the amount of light at the periphery, and the position of the focus lens 211 detected by the lens-position-detecting unit 25, and can receive from the main control unit 62 data indicating, for example, the amount of movement of the focus lens 211.

The aperture drive mechanism 27 changes the diameter of the aperture 23 with a driving force received from an aperture drive actuator 76M via the coupler 75.

The electrical configuration of the camera body 10 will now be described. The camera body 10 includes the imaging device 101, a shutter unit 40, an analog front end (AFE) 5, an image-processing section 61, an image memory 614, the main control unit 62, a flash circuit 63, an operation unit 64, a video random access memory (VRAM) 65, a card interface (I/F) 66, the memory card 67, a communication I/F 68, a power circuit 69, the battery 69B, a mirror drive control unit 72A, a mirror drive actuator 72M, a shutter drive control unit 73A, a shutter drive actuator 73M, an aperture drive control unit 76A, the aperture drive actuator 76M, and an orientation-detecting unit 34.

In the state where the interchangeable lens 2 is mounted on the camera body 10, the imaging device 101 is positioned in and perpendicularly to the optical axis of the lens unit 21 in the interchangeable lens 2. The imaging device 101 employed herein is, for example, a complementary-metal-oxide-semiconductor (CMOS) color area sensor (a CMOS imaging device) in which a plurality of pixels each including a photodiode are arranged in a two-dimensional matrix. The imaging device 101 generates analog electrical signals (image signals) for red (R), green (G), and blue (B) color components of the light from the object received thereon through the interchangeable lens 2, and outputs the signals as image signals for the R, G, and B color components.

A timing control circuit 51, which will be described below, controls imaging operations of the imaging device 101, including the start (and end) of an exposure operation of the imaging device 101, the selection of outputs from the pixels of the imaging device 101, and the reading of image signals.

The shutter unit 40 is provided in front of the imaging device 101 in the optical-axis direction and includes a screen member movable in the vertical direction. The screen member, which is openable and closable, functions as a mechanical focal-plane shutter that opens and blocks the optical path of the light from the object guided to the imaging device 101 along the optical axis of the interchangeable lens 2. The shutter unit 40 can be omitted if the imaging device 101 has a function of a fully electronic shutter.

The AFE 5 supplies timing pulses for causing the imaging device 101 to perform specific operations. Furthermore, the AFE 5 performs specific signal-processing operations on image signals (a group of analog signals optically received by the pixels of the CMOS area sensor) that are output from the imaging device 101, converts the processed image signals into digital signals, and outputs the digital signals to the image-processing section 61. The AFE 5 includes the timing control circuit 51, a signal-processing unit 52, and an analog-to-digital (A-D) conversion unit 53.

The timing control circuit 51 generates and outputs to the imaging device 101 specific timing pulses (including a vertical-scan pulse φVn, a horizontal-scan pulse φVm, and a pulse that generates a reset signal φVr or the like) with reference to a reference clock pulse that is output from the main control unit 62, thereby controlling the shooting operation of the imaging device 101. The timing control circuit 51 also controls the operations of the signal-processing unit 52 and the A-D conversion unit 53 by outputting respective timing pulses thereto.

The signal-processing unit 52 performs specific analog-signal-processing operations on the analog image signals output from the imaging device 101. The signal-processing unit 52 includes a correlated-double-sampling (CDS) circuit, an automatic-gain-control (AGC) circuit, and a clamp circuit. The A-D conversion unit 53 converts, with reference to the timing pulses output from the timing control circuit 51, the analog image signals for the R, G, and B color components output from the signal-processing unit 52 into digital image signals each expressed by a plurality of bits (for example, 12 bits).

The image-processing section 61 performs a specific signal-processing operation on the image data that is output from the AFE 5 and creates an image file. The image-processing section 61 includes a black-level-correction circuit 611, a white-balance (WB) correction circuit 612, and a gamma correction circuit 613. The image data taken into the image-processing section 61 is temporarily written into the image memory 614 synchronously with the reading from the imaging device 101. The image data written in the image memory 614 is subsequently accessed and is processed by relevant blocks in the image-processing section 61.

The black-level-correction circuit 611 corrects the black level defined by the digital image signals for the R, G, and B color components resulting from the A-D conversion by the A-D conversion unit 53 to a reference black level.

The WB correction circuit 612 changes the levels of (adjusts the white balance between) the digital signals for the R, G, and B color components with reference to a reference white value varying with the type of the light source. Specifically, with reference to WB adjustment data supplied from the main control unit 62, the WB correction circuit 612 identifies a portion of an object to be shot that is assumed to be white judging from data on, for example, the brightness and color saturation of the object, and calculates the average levels of the R, G, and B color components and the G-R and G-B ratios at the portion, thereby correcting the levels of the R and B color components with the calculated values taken as correction gains.

The gamma correction circuit 613 corrects the gray scale of the image data that has undergone WB adjustment. Specifically, the gamma correction circuit 613 performs nonlinear conversion of the level of each of the color components of the image data with reference to a gamma correction table prepared in advance, and further performs offset adjustment.

The image memory 614 temporarily stores, in a shooting mode, image data that is output from the image-processing section 61, and is used as a workspace in which the main control unit 62 performs a specific processing operation on the image data. In a reproduction mode, the image memory 614 temporarily stores image data read from the memory card 67.

The main control unit 62 is a microcomputer including storage units such as a ROM that stores, for example, control programs and a random access memory (RAM) that temporarily stores data. The main control unit 62 controls the operations of relevant units of the imaging apparatus 1.

The main control unit 62 also functions as a processor that detects through the touch panel 332 a position on the display screen 33f of the rear monitor unit 33 touched with a thumb Fp and performs a processing operation corresponding to the touched position.

The flash circuit 63 controls, in a flash shooting mode, the amount of light emitted from the flash 318 or an external flash connected to the connection terminal 319 so as to be a value set by the main control unit 62.

The operation unit 64 includes the mode-setting dial 306, the shutter button 307, the directional keypad 314, the push button 315, the main switch 317, and the like, with which pieces of operational information are input to the main control unit 62.

The rear monitor unit 33 includes the LCD 331 and the touch panel 332, which is transparent, provided over the LCD 331.

The LCD 331 can be switched between the displaying state (the light-on state) and the non-displaying state (the light-off state) by switching the power between on and off with, for example, the monitor-operating button 324.

The touch panel 332 functions as a touched-position detector that detects a position on the display screen 33f of the rear monitor unit 33 touched by a user, and accepts an input made by the user with such a touch.

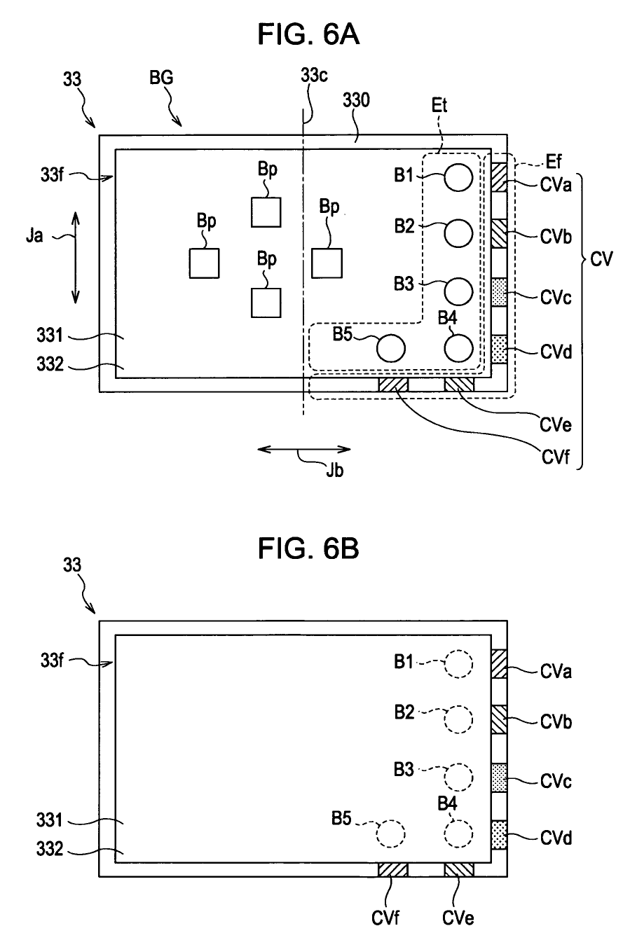

In the rear monitor unit 33 configured as above, when the eye-approach-detecting unit 15 detects the approach of an eye of a user, the light of the rear monitor unit 33 is turned off for prevention of the glare of the display screen 33f and for power saving. Even in the state where the light of the rear monitor unit 33 is off, some of touch buttons (icons B1 to B5 shown in FIGS. 6A and 6B) on the touch panel 332 remain active, i.e., in an on state as described below, whereas the others (tracking-use AF frames Bp shown in FIG. 6A) are in an off state.

The VRAM 65 has an image-signal-storage capacity corresponding to the number of pixels of the LCD 331 and functions as a buffer memory between the main control unit 62 and the LCD 331. The card I/F 66 is an interface enabling the transmission and reception of signals between the memory card and the main control unit 62. The memory card 67 is a storage medium that stores image data generated by the main control unit 62. The communication I/F 68 is an interface enabling the transmission of image data and the like to an external apparatus such as a personal computer.

The power circuit 69 includes, for example, a constant-voltage circuit and generates a voltage with which the entirety of the imaging apparatus 1, i.e., the control units including the main control unit 62, the imaging device 101, and the drive units, are driven. The application of power to the imaging device 101 is controlled in accordance with a control signal supplied from the main control unit 62 to the power circuit 69. The battery 69B is a secondary battery, such as a nickel-hydrogen rechargeable battery, or a primary battery, such as an alkaline dry cell, and functions as a power supply that supplies power to the entirety of the imaging apparatus 1.

The mirror drive control unit 72A generates a drive signal causing the mirror drive actuator 72M to be driven synchronously with the timing of the shooting operation. The mirror drive actuator 72M causes the mirror unit 103 (a quick-return mirror) to turn to be in a level position or in an inclined position.

The shutter drive control unit 73A generates a drive control signal for the shutter drive actuator 73M in accordance with a control signal supplied from the main control unit 62. The shutter drive actuator 73M drives the shutter unit 40 to open and close.

The aperture drive control unit 76A generates a drive control signal for the aperture drive actuator 76M in accordance with a control signal supplied from the main control unit 62. The aperture drive actuator 76M applies a driving force to the aperture drive mechanism 27 via the coupler 75.

The orientation-detecting unit 34 detects the orientation of the imaging apparatus 1, specifically, whether the imaging apparatus 1 is in a horizontal orientation (the normal orientation) or in the vertical orientation, with a gyrosensor (not shown) or the like provided inside the camera body 10. In the detection of the vertical orientation, the orientation-detecting unit 34 can further detect whether the grip 303 is positioned at the top or at the bottom.

### Basic Configuration of Rear Monitor Unit 33

The imaging apparatus 1 includes the eye-approach-detecting unit 15 on the lower side of the optical finder 316, as described above. When the eye-approach-detecting unit 15 detects the approach of an eye of a user to the optical finder 316, the light of the rear monitor unit 33 is turned off for prevention of the glare of the display screen 33f and for power saving. In the state where the light of the rear monitor unit 33 is off, the LCD 331 is in the non-displaying state. However, not the entirety of the touch panel 332 is inactivated, and some regions of the touch panel 332 are maintained to be active. The regions of the touch panel 332 that are maintained to be active will now be described in detail.

FIGS. 6A and 6B illustrate the operation of the touch panel 332 of the imaging apparatus 1. FIG. 6A shows the state where the approach of an eye is not detected by the eye-approach-detecting unit 15 and the light of the rear monitor unit 33 is on. FIG. 6B shows the state where the approach of an eye is detected by the eye-approach-detecting unit 15 and the light of the rear monitor unit 33 is off.

Referring to FIG. 6A, in the state where the approach of an eye is not detected, a plurality of buttons, denoted as a button group BG, provided on the touch panel 332 are displayed on the LCD 331. The button group BG includes four tracking-use AF frames (buttons) Bp intended for designating a person (the face of a person) or the like to be tracked while being focused on in, for example, a live-view image. The button group BG further includes five icons (buttons) B1 to B5 provided in an L-shaped region Et extending from the right side to part of the lower side of the touch panel 332. Specifically, the L-shaped region Et is a hook-shaped region on the right half of the display screen 33f with respect to the center line 33c thereof, and is defined by a right-end region (for example, a region about ⅙ of the display screen 33f from the right end thereof) and a bottom-end region (for example, a region about ⅓ of the display screen 33f from the bottom end thereof). The icons B1 to B5 defined as five circular regions are provided within the L-shaped region Et, and initiates respective different processing operations when touched. The icons B1 to B4 are arranged in the vertical direction Ja of the display screen 33f, and the icons B4 and B5 are arranged in the horizontal direction Jb of the display screen 33f.

The five icons B1 to B5 have functions of changing the mode to, for example, an ISO-speed-setting mode, a WB-setting mode, a drive mode in which continuous shooting or single shooting is set, an exposure correction mode, and a mode in which use or nonuse of the flash 318 is set, respectively.

The icons B1 to B5 are arranged in the L-shaped region Et of the touch panel 332, as described above, for reasons described below.

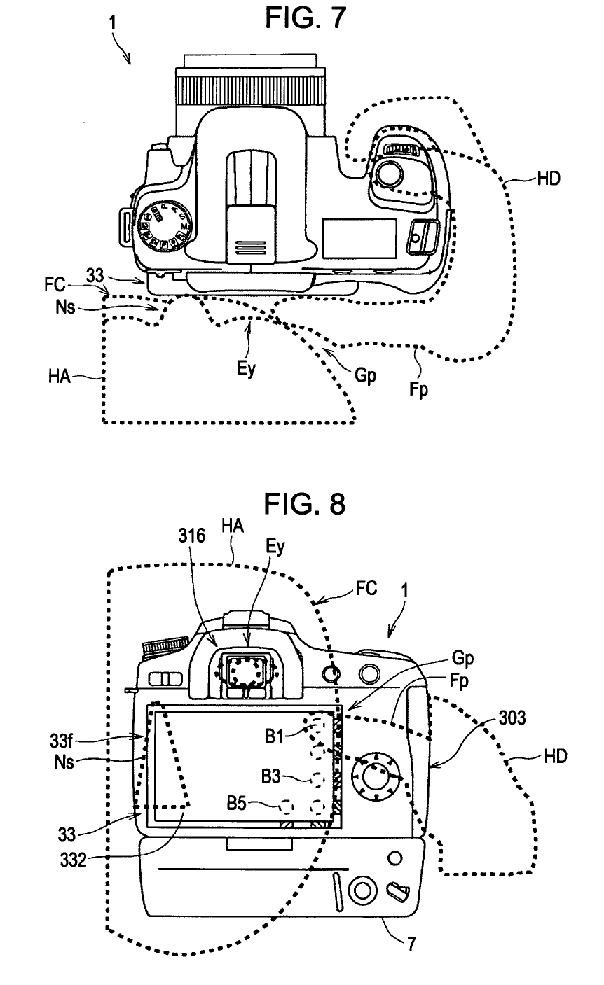

FIGS. 7 and 8 illustrate the reasons for arranging the icons B1 to B5 in the L-shaped region Et of the touch panel 332. FIGS. 7 and 8 are a top view and a rear view, respectively, in a state where a user is holding the imaging apparatus 1 in the horizontal orientation (the normal orientation) with the user's right eye Ey being positioned close to the optical finder 316. The user's head HA and right hand HD are shown by broken lines.

Referring to FIG. 7, when the right eye Ey approaches the optical finder 316, the nose Ns also approaches the rear monitor unit 33 and may touch the touch panel 332. Meanwhile, a gap Gp is produced between a cheek of the face FC and the rear monitor unit 33, allowing the thumb Fp to be placed in the gap Gp.

Therefore, in the imaging apparatus 1, when the eye-approach-detecting unit 15 of the optical finder 316 detects the approach of a user's eye, the touch panel 332 falls into a state where the tracking-use AF frames Bp (see FIG. 6A) provided in the region (other than the L-shaped region Et) where the nose Ns may touch the touch panel 332 are inoperable by being touched. Whereas, the icons B1 to B5 provided in the L-shaped region Et (see FIG. 6A) are each maintained to be operable with a touch. The L-shaped region Et of the touch panel 332 is within reach of the tip of the thumb Fp placed in the gap Gp between the face FC and the rear monitor unit 33. In the L-shaped region Et, the face FC does not prevent touching with the thumb Fp. In short, when an eye approaches the optical finder 316, the display screen 33f of the rear monitor unit 33 falls into the non-displaying state, but processing operations of the imaging apparatus 1 each initiated by a touch detected in the L-shaped region Et of the touch panel 332, corresponding to a region of the display screen 33f where the face FC does not prevent touching with the thumb Fp, are only effective.

When a user looks through the optical finder 316 and the eye-approach-detecting unit 15 detects the approach of the user's eye, the light of the rear monitor unit 33 is turned off because the user does not directly view the rear monitor unit 33. Accordingly, referring to FIG. 6B, the icons B1 to B5 that remain in the operable state become undisplayed. Therefore, to touch-operate a desired one of the icons B1 to B5, the user has to feel for the desired icon. Under such circumstances, it is highly possible that an unintended one of the icons B1 to B5 will be touched. To avoid this, the imaging apparatus 1 according to the embodiment is provided with guides CV on the frame 330 so that the icons B1 to B5 in the undisplayed state can be touched. By feeling the guides CV with a portion of the thumb Fp near the base thereof, the user can find the positions of the icons B1 to B5 even if the light of the display screen 33f is off.

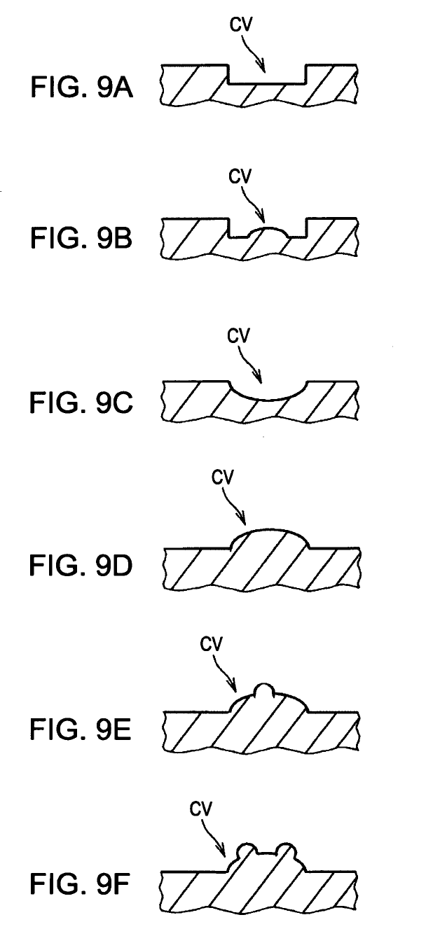

Specifically, a region of the frame 330 adjoining the L-shaped region Et of the touch panel 332 is defined as an L-shaped region Ef, and six guides CV (CVa to CVf) having a concave or convex shape or a combination of concave and convex shapes are provided at positions in the L-shaped region Ef adjacent to the respective icons B1 to B5. In other words, the frame 330 surrounding the touch panel 332 has at positions adjacent to the respective icons B1 to B5 the guides CV that guides a user's digit to the icons B1 to B5. The guides CV provided on the frame 330 includes the guides CVa to CVf having individually different profiles. Exemplary profiles are shown in FIGS. 9A to 9F. Thus, a user can distinguish the guides CVa to CVf from each other with the thumb Fp of the right hand HD and can smoothly touch a desired one of the icons B1 to B5 just by feeling.

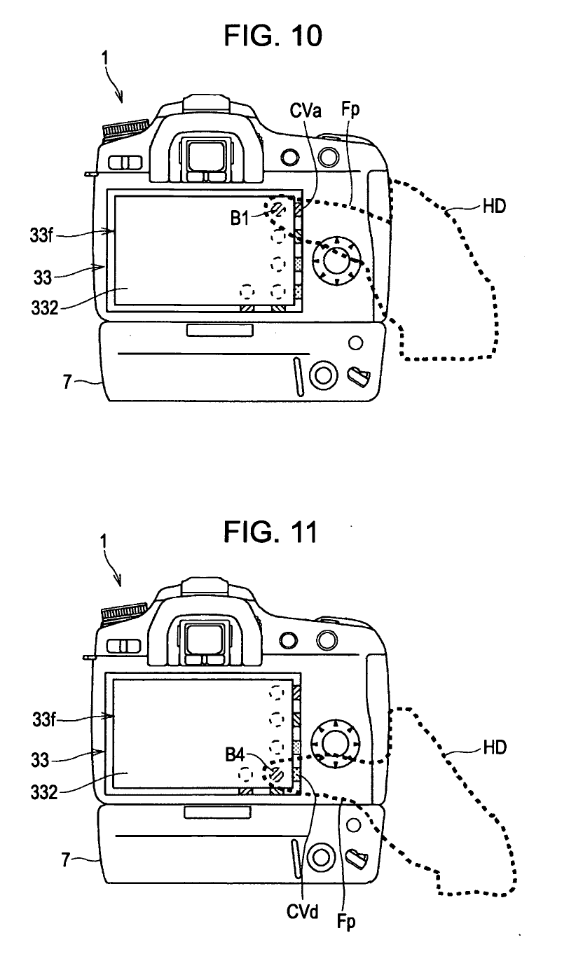

With the guides CV, referring to each of FIGS. 10 and 11 showing the imaging apparatus 1 in the horizontal orientation held by the right hand HD, a user can properly touch-operate, for example, the icon B1 or B4 by distinguishing the corresponding guide CVa or CVd from the others with the thumb Fp even in the state where the approach of an eye is detected by the eye-approach-detecting unit 15 and the light of the rear monitor unit 33 is therefore off.

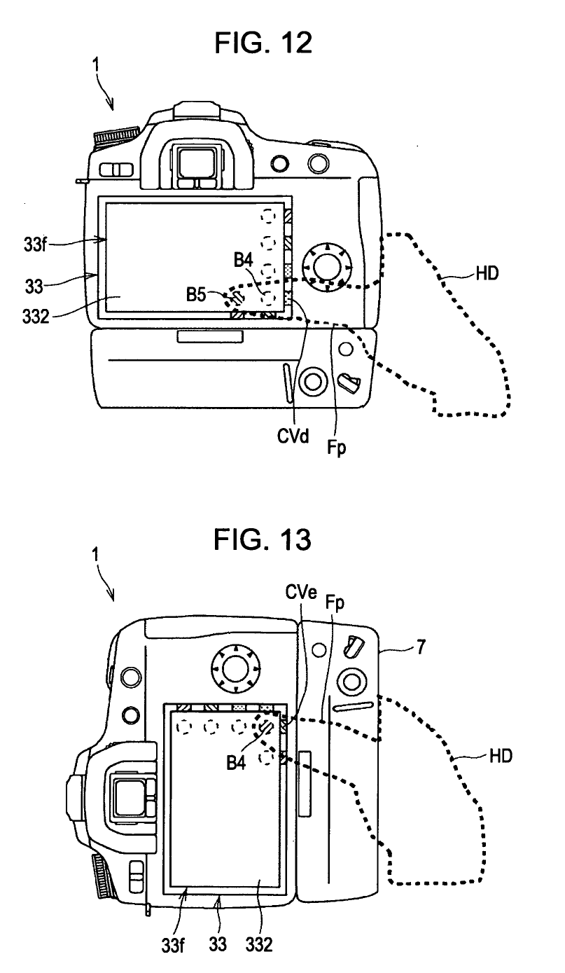

Referring now to FIG. 12, to touch the icon B5 by distinguishing the guide CVd from the others with the thumb Fp, the thumb Fp may also touch the icon B4 covered by a portion near the base thereof. In such a case, the main control unit 62 that has received from the orientation-detecting unit 34 the result of detection that the imaging apparatus 1 is in the horizontal orientation assumes that the thumb Fp of the right hand HD holding the grip 303 is reaching out toward the left. Accordingly, the main control unit 62 identifies the icon at the tip of the thumb Fp, i.e., the icon nearer to the center of the touch panel 332, and allows only the operation of the identified icon B5 by the user while prohibiting the operation of the other icon B4. The two icons B4 and B5 provided in the bottom-end region of the display screen 33f are arranged in the horizontal direction Jb (see FIG. 6A) of the rear monitor unit 33. When these icons B4 and B5 are simultaneously touched by the thumb Fp reached out in the horizontal direction Jb, only the processing operation corresponding to the touch on the icon B4 nearer to the tip of the thumb Fp is performed by the main control unit 62. Thus, even if a plurality of icons are simultaneously touched with a single thumb Fp, a proper processing operation corresponding to the icon intended by the user can be performed.

FIG. 13 shows the imaging apparatus 1 in the vertical orientation with the vertical-orientation control grip 7 attached thereto. Here, if the approach of an eye is detected and the light of the rear monitor unit 33 is turned off, the user can properly operate the icon B4 by distinguishing the guide CVe from the others with the thumb Fp of the right hand HD holding the vertical-orientation control grip 7. In such a case where an eye is positioned close to the optical finder 316 of the imaging apparatus 1 in the vertical orientation, the L-shaped region Et of the touch panel 332 is also effective as a region of the display screen 33f in which the face FC does not prevent touching with the user's thumb Fp.

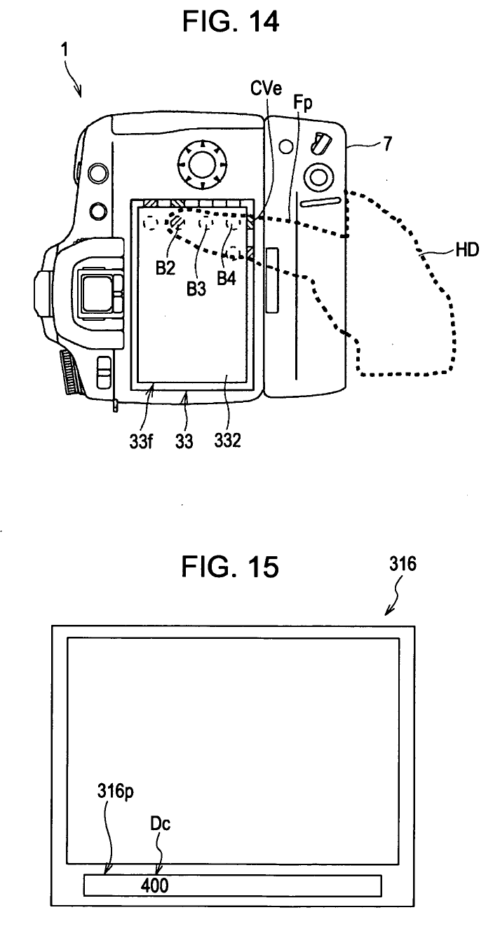

Specific operations of the icons B1 to B5 of the imaging apparatus 1 in the vertical orientation will now be considered. Referring to FIG. 14, to touch-operate the icon B2 by distinguishing the corresponding guide CVe from the others with the thumb Fp, the thumb Fp may also touch the icons B3 and B4 covered by a portion near the base thereof. In such a case, the main control unit 62 that has received from the orientation-detecting unit 34 the result of detection that the imaging apparatus 1 is in the vertical orientation assumes that the thumb Fp of the right hand HD holding the gripped portion 70 of the vertical-orientation control grip 7 is reaching out. Accordingly, the main control unit 62 identifies the icon at the tip of the thumb Fp, i.e., the icon nearest to the optical finder 316, and allows only the operation of the icon B2 by the user while prohibiting the operations of the other icons B3 and B4. The four icons B1 to B4 provided in the right-end region of the display screen 33f are arranged in the vertical direction Ja (see FIG. 6A) of the display screen 33f. When three icons B2 to B4 of the four icons B1 to B4 are simultaneously touched by the thumb Fp reached out in the vertical direction Ja, only the processing operation corresponding to the touch on the icon B2 nearest to the tip of the thumb Fp is performed by the main control unit 62. In this case, the orientation-detecting unit 34 detects that the imaging apparatus 1 is in the vertical orientation with the grip 303 being positioned at the top. Thus, the main control unit 62 recognizes that the icon nearest to the tip of the thumb Fp, i.e., the icon nearest to the optical finder 316, among the three icons B2 to B4 that are touched simultaneously is the icon B2, not the icon B4.

When a user operates the icon B1, to which, for example, the ISO-speed-setting mode is allocated, in the state where the approach of an eye is detected by the eye-approach-detecting unit 15, the current ISO speed “400”, an ISO-speed indication Dc shown in FIG. 15, is displayed in the information display area 316p of the optical finder 316. The value of the ISO speed can be changed with the operation dial 92 or 73, or the directional keypad 314. For example, when the tip of the thumb Fp is slid from the icon B1 to the icon B2, the value displayed in the information display area 316p is changed to a value set for the item (the WB-setting mode) allocated to the icon B2.

In the imaging apparatus 1 according to the embodiment, the light of the rear monitor unit 33 can be turned off by operating the monitor-operating button 324, although the icons B1 to B5 provided in the L-shaped region Et of the touch panel 332 are maintained to be operable. Therefore, even if the display screen 33f of the rear monitor unit 33 is in the non-displaying state, the imaging apparatus can perform a processing operation corresponding to a detected touched position, i.e., any of the icons B1 to B5, in the L-shaped region Et of the touch panel 332. That is, a desired one of the icons B1 to B5 can be touch-operated by feeling the guides CV provided on the frame 330, as described above. In this case, the current value or the like set for the item allocated to the desired icon is displayed on the top display panel 91. In short, when the display screen 33f is in the non-displaying state, information on the processing operation corresponding to the detected touched position in the L-shaped region Et of the touch panel 332 is displayed on the top display panel 91. Thus, in night-view shooting and theater-scene shooting where a user performs the shooting operation without looking through the optical finder 316 and with the light of the rear monitor unit 33 being off, the user can smoothly operate the icons B1 to B5 by feeling the guides CV while checking the result of the operation on the top display panel 91.

In the imaging apparatus 1 configured and operating as above, the icons B1 to B5 provided on the touch panel 332 are arranged in the L-shaped region Et (see FIG. 6A). Therefore, in the state where an eye is positioned close to the optical finder 316, any of the icons B1 to B5 can be touch-operated with the thumb Fp placed in the gap Gp between the face FC and the touch panel 332. Thus, the touch panel 332 is effectively utilized while an eye is positioned close to the optical finder 316.

In the imaging apparatus 1 configured and operating as above, when a plurality of touches with the thumb Fp on a plurality of icons among the five icons B1 to B5 arranged in the L-shaped region Et are simultaneously detected on the touch panel 332, only the touch on the icon nearest to the tip of the thumb Fp is accepted. Thus, even if a plurality of touches with a single digit are simultaneously detected, an intended processing operation is performed.

The imaging apparatus 1 may be used in the vertical orientation without the vertical-orientation control grip 7. Also in such a case, a plurality of icons among the five icons B1 to B5 on the touch panel 332 may be simultaneously touched with a single digit, as described above.

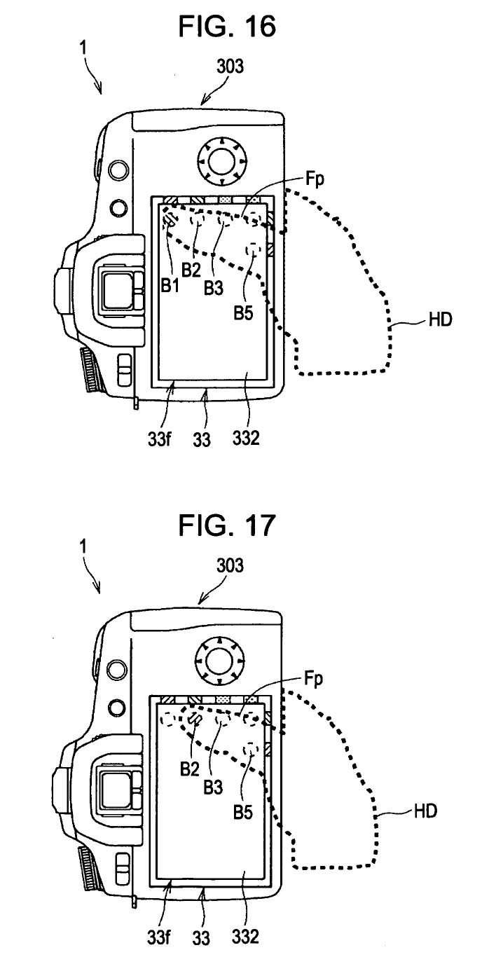

For example, when touch-operating the icon B1 or B2 is attempted with the thumb Fp of the right hand HD as shown in FIG. 16 or 17, the thumb Fp may also touch the icons B3 and B5. In this case, as described above, the main control unit 62 identifies the icon at the tip of the thumb Fp, i.e., the icon nearest to the optical finder 316, and allows only the operation of the identified icon B1 (in FIG. 16) or B2 (in FIG. 17) touched by the user.

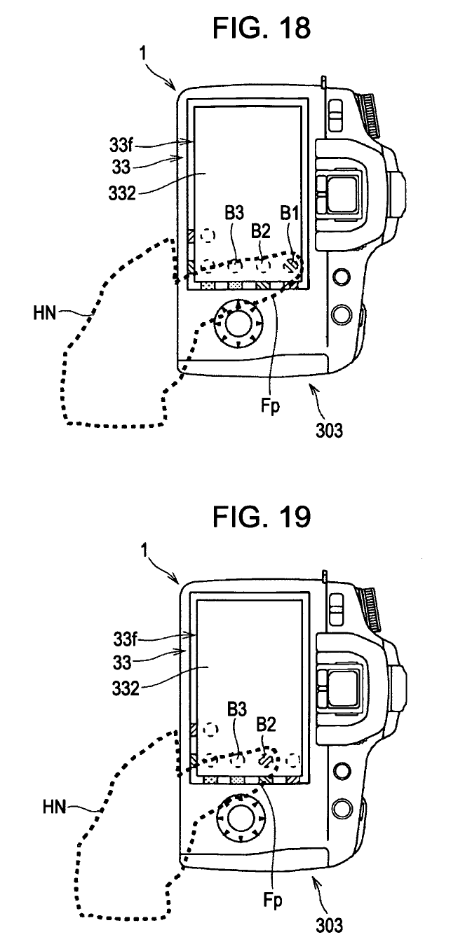

When touch-operating the icon B1 or B2 is attempted with the thumb Fp of the left hand HN as shown in FIG. 18 or 19, the thumb Fp may also touch the icon B3. Also in this case, the main control unit 62 identifies the icon at the tip of the thumb Fp, i.e., the icon nearest to the optical finder 316, and allows only the operation of the identified icon B1 (in FIG. 18) or B2 (in FIG. 19) touched by the user. The imaging apparatus 1 is in the vertical orientation in both cases where touch-operating an icon is attempted with the thumb Fp of the left hand HN, as in FIGS. 18 and 19, and with the thumb Fp of the right hand HD, as in FIGS. 16 and 17, but the positions of the icon at the tip of the thumb Fp relative to the other icons are opposite in the two cases. In this respect, the main control unit 62 can assume whether the imaging apparatus 1 is held by the right hand HD or the left hand HN in accordance with the result of detection by the orientation-detecting unit 34 showing whether the grip 303 is positioned at the top or at the bottom. Thus, the main control unit 62 determines that the touch is made by the thumb Fp of the detected hand and identifies the icon at the tip of the thumb Fp.

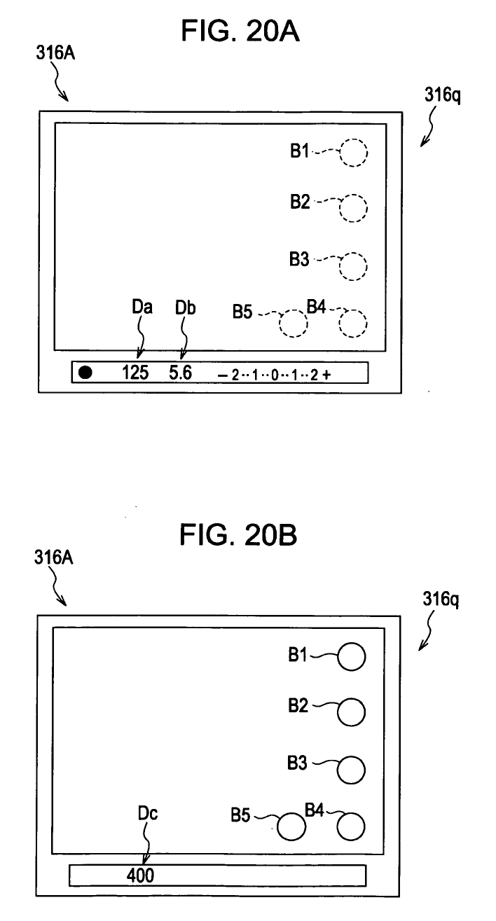

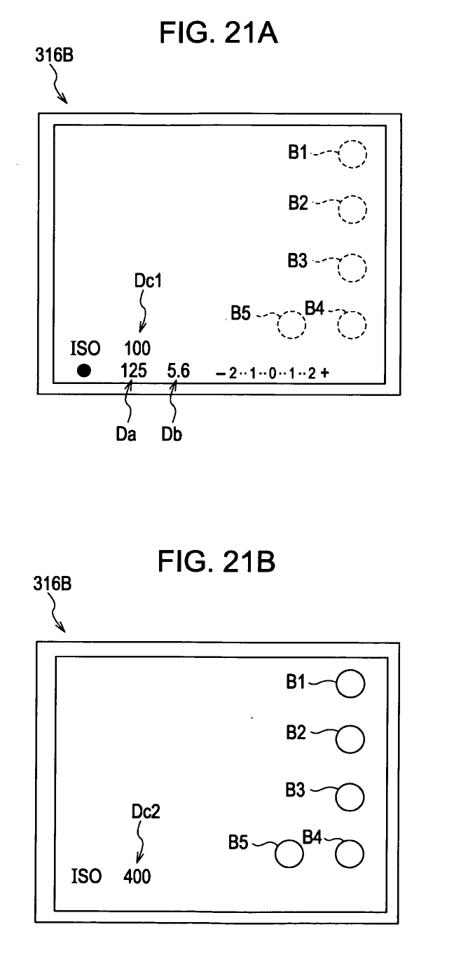

The ocular finder may be an optical finder 316A shown in FIGS. 20A and 20B, or an electronic view finder 316B shown in FIGS. 21A and 21B, instead of the optical finder 316 (shown in FIG. 4) having the information display area 316p at the bottom thereof. The display operation performed when any of the icons B1 to B5 provided in each of the finders 316A and 316B is touch-operated will now be described.

FIGS. 20A and 20B illustrate the display operation of the optical finder 316A performed when any of the icons B1 to B5 is touch-operated.

The optical finder 316A includes an information display area 316q. Information can be displayed on the entirety of the information display area 316q, including a region in which an object image is displayed through a liquid crystal display panel (not shown) provided in the optical path of the optical finder 316A. The liquid crystal display panel of the optical finder 316A does not have an image display function such as that of the electronic view finder 316B, which will be described below.

In the optical finder 316A configured as above, when any of the icons B1 to B5 on the touch panel 332 is touch-operated while the approach of an eye is detected by the eye-approach-detecting unit 15, the information displayed on the information display area 316q of the optical finder 316A changes, as in the case of the optical finder 316 described above. For example, when the icon B1 to which the ISO-speed-setting mode is allocated is touch-operated, the information on the information display area 316q changes from the shutter-speed indication Da and the f-number indication Db (shown in FIG. 20A), displayed before the detection of the eye approach, to the ISO-speed indication Dc (shown in FIG. 20B). Furthermore, in the optical finder 316A, the icons B1 to B5 that were undisplayed on the information display area 316p before the detection of the eye approach, as in FIG. 20A, become displayed in response to the detection of the eye approach, as in FIG. 20B. Thus, the user is notified that the icons B1 to B5 on the touch panel 332 are effective even in the state where the eye is positioned close to the optical finder 316A. In addition, not all the five icons B1 to B5 may be displayed in the information display area 316q in response to the detection of the eye approach. It is also acceptable that only one icon operated by the user is displayed.

FIGS. 21A and 21B illustrate the display operation of the electronic view finder 316B performed when any of the icons B1 to B5 is touch-operated.

The electronic view finder 316B is, for example, a finder that allows a user to view an object image by displaying on a liquid crystal display panel the object image acquired by the imaging device 101.

In the electronic view finder 316B configured as above, when any of the icons B1 to B5 on the touch panel 332 is touch-operated while the approach of an eye is detected by the eye-approach-detecting unit 15, the information displayed on the electronic view finder 316B changes, as in the case of the optical finder 316A described above. For example, when the icon B1 to which the ISO-speed-setting mode is allocated is touch-operated, the information on the electronic view finder 316B changes from the shutter-speed indication Da, the f-number indication Db, and an ISO-speed indication (the current value “100”) Dc1 shown in FIG. 21A displayed before the detection of the eye approach, to only an ISO-speed indication (a value “400” to which the setting has been changed) Dc2 shown in FIG. 21B. The ISO-speed indication Dc2 may be displayed in a different color from the indication Dc1 displayed before the detection of the eye approach. Furthermore, in response to the detection of the eye approach, the icons B1 to B5 that were undisplayed on the electronic view finder 316B before the detection of the eye approach, as in FIG. 21A, become displayed as shown in FIG. 21B, as in the case of the optical finder 316A.

Also in each of the optical finder 316A and the electronic view finder 316B, the user can confirm the result of the operation corresponding to any of the icons B1 to B5 that the user has touch-operated, as in the case of the optical finder 316.

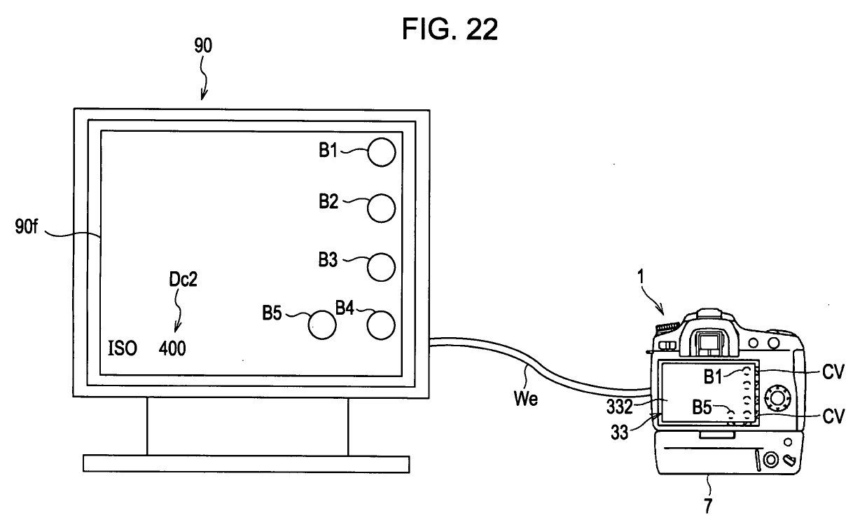

FIG. 22 shows the imaging apparatus 1a to which an external monitor 90 is connected via a cable We such as a video cable or a high-definition-multimedia-interface (HDMI) cable in such a manner that the imaging apparatus 1 and the external monitor 90 can communicate with each other and that an image shot by the imaging apparatus 1 can be, for example, reproduced on the external monitor 90. Also in this case, a user can perform intended operations in correspondence with the icons B1 to B5 with the aid of the guides CV. Specifically, when the external monitor 90 is connected to the imaging apparatus 1, the light of the rear monitor unit 33 is turned off for power saving. Instead, the icons B1 to B5 on the touch panel 332 are displayed on a display screen 90f of the external monitor 90 as shown in FIG. 22. Furthermore, information such as the ISO-speed indication Dc2 is displayed on the external monitor 90 so that the user can check the result of the operation performed by feeling for a desired one of the icons B1 to B5. Thus, the user can smoothly operate the icons B1 to B5.

### Variations

The guides CV according to the above embodiment may be differentiated from each other by being formed to have different surface conditions, including the degree of surface roughness, instead of being formed to have different shapes as shown in FIGS. 9A to 9F.

The imaging apparatus 1 according to the above embodiment may be without the top display panel 91. In such a case, when, for example, a touch on any of the icons B1 to B5 on the touch panel 332 is detected while the light of the rear monitor unit 33 is off as a result of operating the monitor-operating button 324, the light of the rear monitor unit 33 is turned on and information on the setting corresponding to the touched icon is displayed. That is, if the display screen 33f of the rear monitor unit 33 is in the non-displaying state, the display screen 33f is switched to the displayed state in response to the detection of a touch on a position in the L-shaped region Et of the touch panel 332, i.e., a touch on any of the icons B1 to B5. Thus, even without the top display panel 91, the user can check the result of the operation performed by touching a desired one of the icons B1 to B5.

The above embodiment may be applied to a silver-halide camera (a film camera), instead of a digital camera.

The above embodiment may be applied to, instead of an imaging apparatus, an information-processing apparatus (an electronic apparatus) such as a personal digital assistant (PDA) or a mobile terminal equipped with a monitor having a touch panel. Also in such a case, when a plurality of touches with a single digit are detected, the touch at the tip of the digit is identified and only the operation corresponding to the touch is accepted. Thus, a proper operation corresponding to the touch is performed.

In the above embodiment, the detection of a touched position may be realized with, instead of a touch panel, rays such as infrared rays emitted in a grid pattern over the display screen or rays scanned over the display screen, for example. In such a case, a touched position is optically detected by detecting a position where such rays are blocked.

It should be understood by those skilled in the art that various modifications, combinations, sub-combinations and alterations may occur depending on design requirements and other factors insofar as they are within the scope of the appended claims or the equivalents thereof.

What is claimed is:

1. An information-processing apparatus comprising:
a display unit having a display screen; and
processing means for detecting a touched position on the display screen and performing a processing operation corresponding to the touched position,
wherein the display screen has two or more regions arranged in a predetermined direction and being corresponding to respective different processing operations, and
wherein the processing means includes limited-operation-processing means for limitedly performing, when a plurality of regions among the two or more regions are simultaneously touched with a first digit reached out in the predetermined direction, a processing operation corresponding to a first region nearest to the tip of the first digit.

2. An imaging apparatus comprising:
a display unit having a display screen; and
processing means for detecting a touched position on the display screen and performing a processing operation corresponding to the touched position,
wherein the display screen has two or more regions arranged in a predetermined direction and being corresponding to respective different processing operations, and
wherein the processing means includes limited-operation-processing means for limitedly performing, when a plurality of regions among the two or more regions are simultaneously touched with a first digit reached out in the predetermined direction, a processing operation corresponding to a first region nearest to the tip of the first digit.

3. The imaging apparatus according to claim 2, further comprising a grip to be gripped and provided on a lower side of the display unit,
wherein the two or more regions are arranged in a right-end region of the display screen and in a vertical direction of the display screen.

4. The imaging apparatus according to claim 2, further comprising a grip to be gripped and provided on a right side of the display unit,
wherein the two or more regions are arranged in a lower-end region of the display screen and in a horizontal direction of the display screen.

5. The imaging apparatus according to claim 3, wherein guides are provided around the display screen in correspondence with the two or more regions, the guides being positioned near the two or more regions, respectively, and guiding the digit toward the two or more regions, respectively.

6. The imaging apparatus according to claim 5, wherein the guides each have a concave or convex shape or a combination of concave and convex shapes.

7. The imaging apparatus according to claim 2, further comprising an ocular finder provided on an upper side of the display unit,
wherein the two or more regions are arranged within a region of the display screen in which a face does not prevent a touch with the first digit in a state where an eye is positioned close to the finder.

8. An information-processing apparatus comprising:
a display unit having a display screen; and
a processor configured to detect a touched position on the display screen and to perform a processing operation corresponding to the touched position,
wherein the display screen has two or more regions arranged in a predetermined direction and being corresponding to respective different processing operations, and
wherein the processor includes a limited-operation processor for limitedly performing, when a plurality of regions among the two or more regions are simultaneously touched with a first digit reached out in the predetermined direction, a processing operation corresponding to a first region nearest to the tip of the first digit.

9. An imaging apparatus comprising:
a display unit having a display screen; and
a processor configured to detect a touched position on the display screen and to perform a processing operation corresponding to the touched position,
wherein the display screen has two or more regions arranged in a predetermined direction and being corresponding to respective different processing operations, and
wherein the processor includes a limited-operation processor for limitedly performing, when a plurality of regions among the two or more regions are simultaneously touched with a first digit reached out in the predetermined direction, a processing operation corresponding to a first region nearest to the tip of the first digit.
